(19) United States
(12) Patent Application Publication
(10) Pub. No.: US 2007/0168379 A1
(43) Pub. Date: Jul. 19, 2007

(54) Method and apparatus for cataloging screen shots of a program

(76) Inventors: Sushma Bharat Patel, Austin, TX (US); Keiichi Yamamoto, Austin, TX (US); Kin Hung Yu, Austin, TX (US)

Correspondence Address: IBM CORP (YA);C/O YEE & ASSOCIATES PC, P.O. BOX 802333, DALLAS, TX, 75380, US

(21) Appl. No.: 11/333,442

(22) Filed: Jan. 17, 2006

(51) Int. Cl. G06F 7/00

(52) U.S. Cl. 707/102

(57) ABSTRACT

A screen shot of a window of a program is taken. A computer program queries data structures that are a source for aspects of the screen shot. The program objects return text strings associated with the window to the computer program. The computer program associates a unique identifier, the screen shot and the text strings together into a second data structure.

### BACKGROUND OF THE INVENTION

1. Field of the Invention:

The present invention relates generally to a method, apparatus, and computer usable code for documenting a program. More specifically the present invention relates to a method to couple text of at least one data structure with resultant images of the program.

2. Description of the Related Art:

Illustrations and program screen shots contain information that is valuable, but tend to be arranged in a variety of manners. Though a program may be the source for such graphical information, frequently the textual information is reduced to a form that is later captured as a bitmapped image. The bitmapped image, rather than storing text as individual characters, actually stores the text in a more complex and abstract form, a bit field. The bit field is merely an artistic rendition, employing fonts and colors of the shading, sizing, and other motifs of each character. Thus, the bit field contains far too much information for many purposes, and often the wrong kind of information, where an individual character would do just fine. By an individual character, it is meant a code point or computer encoded character such as produced using the American Standard Code for Information Interchange, better known as ASCII, standard well known in the art.

As a result, a number of methods have been employed to glean the ASCII characters from an image. One such method requires optical character recognition, a highly computer intensive operation. Another method involves a human operator hand keying the details of text from an image.

In addition to obtaining information for database purposes, the prior art also has provided a way for vision impaired people to collect text that otherwise would be displayed to a screen. Using this technology, a computer introspects a graphical object that otherwise would display something to a screen. Such an object is sometimes called a widget. Introspection is a cooperative process wherein a first program inspects and queries the data structures of a second program that displays material to a screen. The first program extracts text from the second program, the second program having one or more widgets.

### SUMMARY OF THE INVENTION

The aspects of the present invention provide a computer implemented method, apparatus, and computer usable code for coupling text of a data structure with a resultant image of a program. A screen capture program introspects the data structure to obtain at least one text string. The screen capture program stores the text string to form a second data structure. The screen capture program associates a unique identifier with the second data structure. The screen capture program appends a bitmap of a window to the second data structure, wherein the bitmap is derived from the data structure.

In a preferred embodiment, portions of the bitmap image are associated with introspection results from graphical objects, which display within respective portions of the interface.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 shows a pictorial representation of a data processing system in accordance with an illustrative embodiment of the present invention;

FIG. 2 shows a block diagram of a data processing system in accordance with an illustrative embodiment of the present invention;

FIG. 3 shows the communications between software components in accordance with an illustrative embodiment of the present invention;

FIG. 4A shows a representative target application window in accordance with an illustrative embodiment of the present invention;

FIG. 4B shows a representative target application window with widgets highlighted in accordance with an illustrative embodiment of the present invention;

FIG. 5 shows a tree data structure corresponding to representative target application window in accordance with an illustrative embodiment of the present invention;

FIG. 6 shows a container in accordance with an illustrative embodiment of the present invention; and

FIG. 7A and FIG. 7B show a flowchart of steps executed by a screen capture program in accordance with an illustrative embodiment of the present invention.

### DETAILED DESCRIPTION OF THE PREFERRED EMBODIMENT

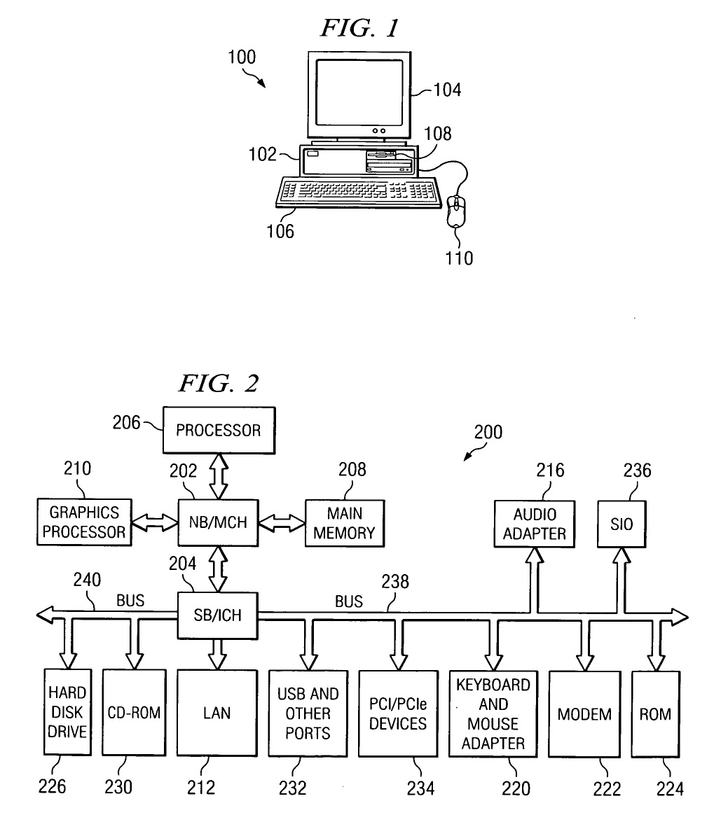

With reference now to the figures and in particular with reference to FIG. 1, a pictorial representation of a data processing system in which the present invention may be implemented, is depicted in accordance with a preferred embodiment of the present invention. Computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM eServer computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

With reference now to FIG. 2, a block diagram of a data processing system is shown in which embodiments of the present invention may be implemented. In the depicted example, data processing system 200 employs a hub architecture including north bridge and memory controller hub (MCH) 202 and south bridge and input/output (I/O) controller hub (ICH) 204. Processing unit 206, main memory 208, and graphics processor 210 connect to north bridge and memory controller hub 202. Graphics processor 210 may connect to north bridge and memory controller hub 202 through an accelerated graphics port (AGP).

In the depicted example, local area network (LAN) adapter 212, audio adapter 216, keyboard and mouse adapter 220, modem 222, read only memory (ROM) 224, hard disk drive (HDD) 226, CD-ROM drive 230, universal serial bus (USB) ports and other communications ports 232, and PCI/PCIe devices 234 connect to south bridge and I/O controller hub 210 through bus 238. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS).

Hard disk drive 226 and CD-ROM drive 230 connect to south bridge and I/O controller hub 204 through bus 240. Hard disk drive 226 and CD-ROM drive 230 may use, for example, an integrated drive electronics (IDE) or serial advanced technology attachment (SATA) interface. Super I/O (SIO) device 236 may be connected to south bridge and I/O controller hub 204.

Thus, a platform for enabling the creation of a database of one or more containers is established. The database may provide a body of easily searched images. Consequently, the embodiments of the present invention relieves readers, searchers and translators from some of the chores and delays in finding the right image.

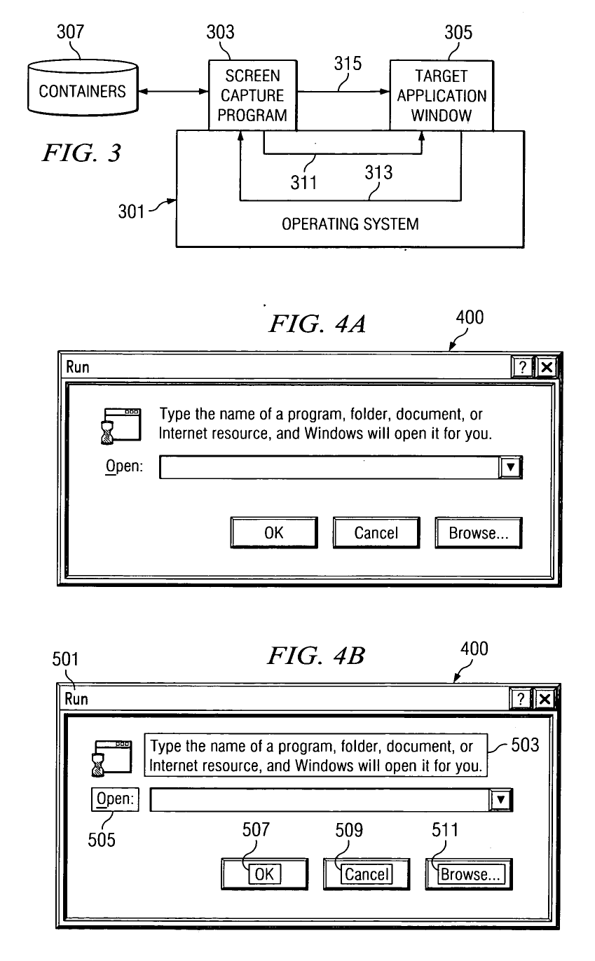

FIG. 3 shows the communications between software components in accordance with an illustrative embodiment of the present invention. The communications shown may comprise steps for introspecting data structures. Introspecting is a process whereby a program catalogs text elements of a target application window. Operating system 301 provides access to system resources of a processor, for example, processor 202 of FIG. 2. Operating system may facilitate inter-process communication that occurs when multiple programs are running in a resource-sharing environment. Target application window 305 may operate on operating system 301 to display information to a display with a graphics processor or other rendering device. Target application window 305 may use system resources to store details of text and graphics that target application window 305 renders to a display.

Screen capture program 303 identifies the top window of a graphical user interface. Alternatively, screen capture program 303 may identify a window that is not yet been captured. Screen capture program 303 identifies, for example, by issuing handle request 311 to operating system 301. Such a request facilitates screen capture program 303 to address queries to target application window 305. Target application window 305 is an example of a graphical user interface. Operating system 301 or target application window 305 may respond with handle 313, wherein screen capture program 303 receives handle 313. Handle 313 is an identifier unique to the application to which handle 313 references such that no two applications have the same handle on operating system 301.

After receiving handle 313, screen capture program 303 uses handle 313 to make at least one query 315 to target application window 305. Querying is a process wherein one program addresses a second program and passes one or more parameters to the second program for evaluation and retrieval of associated information accessible to the second program. Often such information is stored in objects of the second program. FIG. 3 shows the second program to be target application window 305. Results of each query may be stored to container 307. Container 307 is a file stored, for example, on a hard drive or in system memory. Once created, container 307 may have a file name associated with the container. The file name, or the file name combined with an associated path, is unique within the file system that supports container 307 in these examples.

FIG. 4A shows representative target application window 400 in accordance with an illustrative embodiment of the present invention. Target application window 400 may include data structures as well as a resultant image. A resultant image is a computer representation of the two dimensional aspects of an image resulting from the operation of a target application window. A resultant image may be, for example, a bitmap of the visible target application window that a screen capture program operates upon in these examples. In addition, a resultant image may be stored in compressed file formats, for example, JPEG and TIFF formats wherein both the uncompressed form and the compressed form are known as the resultant image.

FIG. 4B shows representative target application window 400 with graphical objects or widgets highlighted in accordance with an illustrative embodiment of the invention. The widgets include window title 501, prompt 503, field name 505, ok 507, cancel 509, and browse 511.

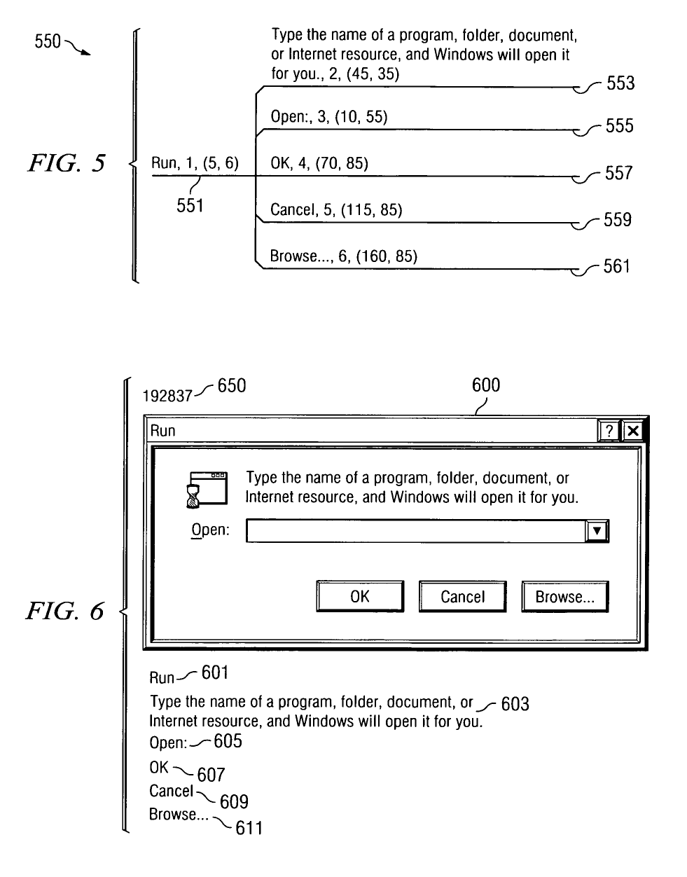

FIG. 5 shows tree data structure 550 corresponding to a representative target application window in accordance with an illustrative embodiment of the present invention. Tree data structure 550 is an example of a data structure created from target application window 400 in FIG. 4B. Tree data structure 550 includes nodes in a hierarchy. Tree data structure 550 is constructed following one or more queries of the target application window. Thus, tree data structure 550 is derived and parallel to the data structure of the target application window, though some non-textual aspects may be absent from the tree data structure 550 version. The target application window creates its own data structure on an ad hoc basis to respond to the transitory requirements of the target application to display information to the screen, and thus, hopefully to a user. Introspection permits a screen capture program, as well as other programs to extract relevant aspects of this data structure by drilling down into the data structure by cooperatively querying the target application window. Other data structures such as linked lists would be alternatives to tree data structure 550 as is well known to those skilled in the art.

A node is a place where information may be stored that may have parent relationships with one or more additional nodes. In addition, a node may have a parent-child relationship with a node. Screen capture program 303 of FIG. 3 may create tree data structure 550 from information obtained from target application window 305 of FIG. 3. Each node may contain information from a widget. The information may include text string, a object identifier, and at least one object coordinate. A object coordinate may be, for example, one or more corners of the widget in relation to some aspect of the display. Tree data structure 550 may be stored, in part, to memory during intervals as a screen capture program assembles the tree data structure 550.

A screen capture program may initially query a target application window and determine that the root widget contains the text string “Run”, and be associated with the object identifier “1”. Additional information may be stored, and consequently retrieved from the root widget, such as a coordinate. The screen capture program assembles this data at root node 551 of the tree data structure 550. In addition, information concerning the identity of child nodes to the root widget are retrieved from the root widget. The child nodes, which are widgets, in this instance, number five. Each of these widgets are queried in turn by screen capture program 303 of FIG. 3. Thus, the widgets are each queried and deliver information that the screen capture program collects. The screen capture program places the details of the five widgets into prompt node 553, field name node 555, ok node 507, cancel node 509, and browse node 511. In many respects, tree data structure 550 parallels the data structure of the target application node once completed.

FIG. 6 shows a container in accordance with an illustrative embodiment of the present invention. The screen capture program may create the container and modify the container. The screen capture program may write an identifier unique to the container 650. In addition, the screen capture program may write a window bitmap 600 to the container. Window bitmap 600 is a computer representation of the two dimensional aspects of an image resulting from the operation of a target application window, otherwise known as a resultant image. Resultant image may be, for example, target application window 400 of FIG. 4A. In addition, the screen capture program may write attributes of widgets to the container, for example, text strings: window title 601, prompt 603, field name 605, OK 607, Cancel 609, and Browse. . . 611.

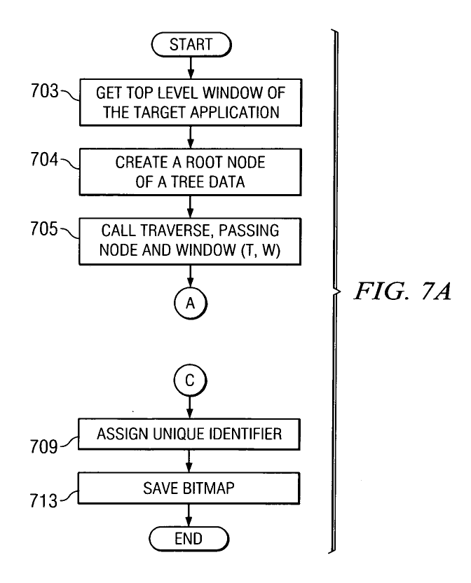

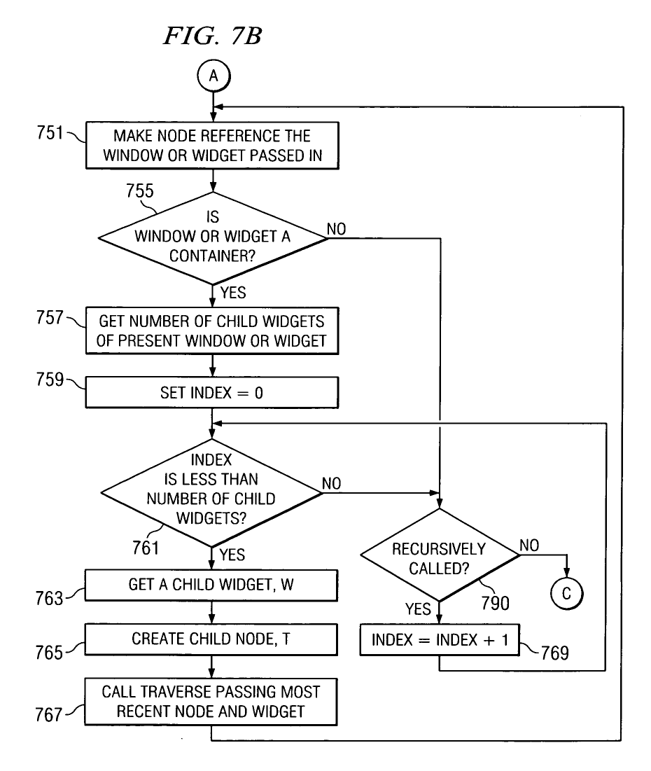

FIG. 7A shows a flowchart of steps executed by a screen capture program in accordance with an illustrative embodiment of the invention. FIG. 7A depicts the main program, which accomplishes introspection of the target application window in a series of steps that includes calling to another series of steps shown more specifically in FIG. 7B, also known as traverse function. Introspection is the process of acquiring the data of displayed windows and widgets of a target application window. The screen capture program is, for example, screen capture program 303 of FIG. 3. The screen capture program may get or receive a target window (step 703), for example, in response to a user applying a pre-programmed keystroke combination. Alternatively, a user may invoke the screen capture program at a command line to operate with the window that currently has focus or is otherwise on top, according to the operation of the operating system. Screen capture program 303 of FIG. 3 may use a Java function to obtain the most prominent window presently displayed. Step 703 may include screen capture program 303 of FIG. 3 requesting the operating system for a handle to the window. The operating system may be, for example, operating system 301 of FIG. 3. The window may be, for example, target application window 305 of FIG. 3. In addition, screen capture program may receive the handle. Screen capture program creates a root node (step 704). The root node forms the basis and a reference point for a tree. Screen capture program calls a traverse function, passing the node and the window (step 705).

Screen capture program calls the traverse function, or series of steps, by passing or otherwise messaging the most recently accessed window and node to a local environment or context. The context exists for the duration that the traverse function operates. Screen capture program creates the context during the call to the traverse function (step 705). Other program calls to the traverse function also create contexts applicable to both program calls. Multiple contexts may exist simultaneously, however, when an iteration of the traverse function ends, one of the contexts is no longer valid, and the screen capture program de-allocates memory formerly reserved for the context.

FIG. 7B shows the traverse function, steps 751 through 790. The call to traverse function is a query of the tree data structure for the window. The traverse function represents a portion of program flow that screen capture program may execute recursively in a process known as recursion. The steps may be entered through step 751 multiple times, each time looking at more and more specific nodes of the tree used by target application window.

Screen capture program, in calling the traverse function, may provide among the parameters a parameter that may be either a window or a widget. Screen capture program determines if the window or widget is a container, that is, that the window or widget contains child nodes (step 755). A determination that the window or widget contains child nodes causes the screen capture program to get the number of child widgets or nodes of the present window or widget (step 757). An index may be set (step 759) in association with the current context. Screen capture program determines if the index is less than the number of widgets (step 761). An affirmative determination causes screen capture program to get a child widget (step 763). Then screen capture program adds a child node to the current node of the tree (step 765). Screen capture program calls the traverse function, passing the most recent node and widget (step 767). Like the call from main program to traverse function, screen capture program forms a separate environment or context for the node and widget passed.

A traverse function returns by two routes. First, a negative result may occur at step 755. Second, a negative result may occur when comparing the index to the number of child widgets at step 761. Each of these results leads to screen capture program determining if the traverse function was recursively called (step 790). An affirmative branch results in screen capture program returning parameters in the current context, and the context to switch to the context of the calling traverse function. The affirmative branch leads to an increment of the index (step 769). Screen capture program follows the increment step with the index test step 761.

A non-recursive call is what occurs when the steps in FIG. 7A are the next context up. In other words, screen capture program last called FIG. 7B steps using the steps in FIG. 7A and not by FIG. 7B. This occurs when a screen capture program traverses every child and descendent node from that child, and has returned to the child context of the root node. Step execution returns to FIG. 7A through connector ‘C’.

Screen capture program assigns a unique identifier to the top window (step 709). Screen capture program saves the bitmap of the top window (step 713).

Access to the displayed contents of a target application makes use of accessibility functions available from the operating system or the graphical user interface window manager, otherwise known as assistive technologies. For example, Java provides accessibility functions through Swing components, a set of software objects that extract user interface text, for example, to assist people who have sight impairments and require specialty rendering apparatus for interacting with the computer. Operating systems such as Windows and integrated development environment such as Eclipse provide other software packages to access target application object information concerning displayed text of target windows.

Thus, a platform for enabling the creation of a database of one or more containers is established. The database may provide a collection of easily searched images, which may be rapidly searched.

Though Swing is widely available for use in Java supporting operating systems, traversing of objects may be performed using other functions to access the data stored in target application windows.

The various embodiments of the invention may enhance the ability to couple or pair the images or graphical outputs from a program with segments of text that were used in a graphical user interface to produce the various images. Such couplings may provide a searchable database, for example, applications that provide online help to new or confused users of the program.

The present invention can take the form of an entirely hardware embodiment, an entirely software embodiment or an embodiment containing both hardware and software elements. In a preferred embodiment, the present invention is implemented in software, which includes but is not limited to firmware, resident software, microcode, etc.

Furthermore, the present invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the present invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for associating text in a data structure describing a set of graphical objects with a resultant image of a displayed graphical object on a computer display comprising:
introspecting the data structure to obtain a text string;
storing the text string in a second data structure;
associating a unique identifier with the second data structure; and
associating the resultant image to the second data structure.

2. The computer implemented method of claim 1, wherein storing further comprises storing an object identifier and an object coordinate in the second data structure.

3. The computer implemented method of claim 1, wherein introspecting further comprises:
requesting a handle from an operating system; receiving the handle; and
traversing the data structure for each graphical object in the data structure.

4. The computer implemented method of claim 3, wherein requesting further comprises:
identifying a window of a graphical user interface.

5. The computer implemented method of claim 1 further comprising:
creating a root node of a tree.

6. The computer implemented method of claim 1, wherein associating the unique identifier further comprises:
storing the unique identifier to the second data structure.

7. The computer implemented method of claim 6, wherein storing further comprises:
selecting the unique identifier wherein the unique identifier is distinct from a second unique identifier associated with a third data structure.

8. A computer program product comprising:
a computer usable medium having computer usable program code for associating text in a data structure describing a set of graphical objects with a resultant image of a displayed graphical object on a computer display, said computer program product including:
computer usable program code for introspecting the data structure to obtain a widget string;
computer usable program code for storing the widget string in a second data structure;
computer usable program code for associating a unique identifier with the second data structure; and
computer usable program code for associating the resultant image to the second data structure.

9. The computer program product of claim 8, wherein computer usable program code for storing further comprises:
computer usable program code for storing a object identifier and a object coordinate to a second data structure.

10. The computer program product of claim 8, wherein computer usable program code for introspecting further comprises:
computer usable program code for requesting a handle from an operating system;
computer usable program code for receiving the handle; and
computer usable program code for traversing the data structure for each widget in the data structure.

11. The computer program product of claim 10, wherein computer usable program code for requesting further comprises:
computer usable program code for identifying a window of a graphical user interface.

12. The computer program product of claim 8, wherein usable program code further comprises:
computer usable program code for creating a root node of a tree.

13. The computer program product of claim 8, wherein computer usable program code for associating further comprises:
computer usable program code for storing the unique identifier to the second data structure.

14. The computer program product of claim 13, wherein computer usable program code for storing further comprises:
computer usable program code for selecting the unique identifier wherein the unique identifier is distinct from a second unique identifier associated with a third data structure.

15. A data processing system comprising:
a bus;
a storage device connected to the bus, wherein computer usable code is located in the storage device;
a communication unit connected to the bus;
a processing unit connected to the bus, wherein the processing unit executes the computer usable code to introspect a data structure to obtain a text string; store the text string in a second data structure; associate a unique identifier with the second data structure; and associate a resultant image to the second data structure, wherein the resultant image is derived from the data structure.

16. The data processing system of claim 15, wherein in executing the computer usable code to store the processing unit further executes the computer usable code to:
store a object identifier and a object coordinate in the second data structure.

17. The data processing system of claim 15, wherein in executing the computer usable code to introspect the processing unit further executes the computer usable code to:
request a handle from an operating system;
receive the handle; and
traverse the data structure for each graphical object in the data structure.

18. The data processing system of claim 17, wherein in executing the computer usable code to request the processing unit further executes the computer usable code to:
identify a window of a graphical user interface.

19. The data processing system of claim 15, wherein in executing the computer usable code to query the processing unit further executes the computer usable code to:
create a root node of a tree.

20. The data processing system of claim 15, wherein in executing the computer usable code to associate the processing unit further executes the computer usable code to:
store the unique identifier in the second data structure.
